(19) United States
(12) Patent Application Publication
(10) Pub. No.: US 2009/0043776 A1
(43) Pub. Date: Feb. 12, 2009

(54) System and method for direct file transfer in a computer network

(75) Inventor: Mark Moshayedi, Newport Coast, CA (US)

Correspondence Address: MCDERMOTT WILL & EMERY LLP, 18191 VON KARMAN AVE., SUITE 500, IRVINE, CA, 92612-7108, US

(73) Assignee: SimpleTech, Inc., Santa Ana, CA (US)

(21) Appl. No.: 11/644,689

(22) Filed: Dec. 23, 2006

(51) Int. Cl. G06F 17/30; G06F 12/00

(52) U.S. Cl. 707/10; 707/201; 707/E17.005; 707/E17.01; 707/E17.032

(57) ABSTRACT

A computing host includes a host processor and a communication processor both coupled in communication with a network and a storage device. The host processor receives a file request for transferring a file between the network the storage device, determines that the file request is to be performed by using a direct file transfer, generates a command based on the file request, and provides the command to the communication processor. The communication processor transfers the file between the network and the storage device based on the command without passing the file through the host processor. Additionally, the communication processor can transmit the file to the network.

### CROSS-REFERENCE TO RELATED APPLICATIONS

The present invention is related to co-pending U.S. patent application Ser. No. ______, entitled “Direct File Transfer Host Processor,” filed on even date herewith; co-pending U.S. patent application Ser. No. ______, entitled “Direct File Transfer Communication Processor,” filed on even date herewith; and co-pending U.S. patent application Ser. No. ______, entitled “Direct File Transfer System and Method for a Computer Network,” filed on even date herewith.

### BACKGROUND

1. Field of Invention

The present invention generally relates to computer networks. More particularly, the present invention relates to systems and methods of transferring a file in a computer network.

2. Description of Related Art

An ever-increasing amount of data is accessible over a computer network, such as the Internet, a local area network, or a wide area network. The data is typically stored in host servers, such as Web page servers, connected to the computer network. An increase in demand for data stored in such host servers has contributed to an increase of network traffic in computer networks and an increase in the resulting overhead in the host servers.

The overhead in a conventional host server involves generating data packets for a file in response to receiving a file request from a computer network. Typically, the host server reads the file from a storage device and stores the file into a memory of the host server. Once the file is in the memory, the host server segments the file into data portions and generates a header for each data portion. The host server then combines each data portion with the header of the data portion to generate a data packet including the data portion and the header. The host server then transmits the data packets to the computer network. Similarly, the host server receives data packets along with a file request from the computer network, constructs a file based on the data packets, and writes the file into the storage device. In addition to processing related to the overhead, the host server may execute applications on the data packets during construction of the file or on the constructed file.

An increase in overhead may cause a performance decrease in the host server. For example, the overhead of the host server may increase as a result of an increase in file requests received by the host server. Moreover, the increase in overhead may cause applications on the host server to execute more slowly. Consequently, the host server becomes a bottleneck in the flow of network traffic through the computer network, which may result in connection timeouts, poor quality media, or slow-loading Web pages.

In light of the above, a need exists for improving performance of a host server. A further need exists for reducing overhead in a host server.

### SUMMARY

In various embodiments, a computing host includes a host processor and a communication processor both coupled in communication with a network and a storage device. The host processor receives a file request for transferring a file between the network and the storage device, and determines whether the file request is to be performed by using a direct file transfer. If the host processor determines that the file request is to be performed by using a direct file transfer, the host processor generates a command based on the file request, and the communication processor transfers the file between the network and the storage device based on the command without passing the file through the host processor. Otherwise, the host processor transfers the file between the network and the storage device based on the file request. In this way, the file is directly transferred between the network and the storage device. Moreover, the overhead of the host processor is reduced and thus the performance of the host processor is increased.

A method for directly transferring a file between a network and a storage device, in accordance with one embodiment, includes receiving a file request by a host processor coupled in communication with the storage device. The method further includes generating a command by the host processor based on the file request in response to receiving the file request and issuing the command from the host processor to a communication processor coupled in communication with the network and the storage device. Additionally, the method includes transferring the file between the network and the storage device based on the command without passing the file through the host processor.

A system for directly transferring a file between a network and a storage device, in accordance with one embodiment, includes a storage device, a host processor, and a communication processor. The host processor is coupled in communication with the storage device. The communication processor is coupled in communication with the host processor and the storage device. The storage device is configured to store the file. The host processor is configured to receive a file request from the network and to generate a command based on the file request. The communication processor is configured to transfer the file between the network and the storage device based on the command without passing the file through the host processor.

### BRIEF DESCRIPTION OF DRAWINGS

The accompanying drawings are included to provide a further understanding of the invention, and are incorporated in and constitute a part of this specification. The drawings illustrate embodiments of the invention, and together with the description, serve to explain the principles of the invention. In the drawings,

FIG. 1 is a block diagram of a computing host, in accordance with an embodiment of the present invention;

FIG. 2 is a block diagram of a communication processor, in accordance with an embodiment of the present invention;

FIG. 3 is a block diagram of a communication processor, in accordance with an embodiment of the present invention;

FIG. 4 is a block diagram of a host processor, in accordance with an embodiment of the present invention;

FIG. 5 is a block diagram of a command, in accordance with an embodiment of the present invention;

FIG. 6 is a block diagram of file attributes, in accordance with an embodiment of the present invention;

FIG. 7 is a block diagram of a data message, in accordance with an embodiment of the present invention;

FIG. 8 is a flow chart of a method of directly transferring a file between a network and a storage device, in accordance with an embodiment of the present invention;

FIG. 9 is a flow chart of a method of directly transferring a file between a network and a storage device, in accordance with an embodiment of the present invention;

FIG. 10 is a flow chart of a method of directly transferring a file between a network and a storage device, in accordance with an embodiment of the present invention;

FIG. 11 is a flow chart of a method of directly transferring a file between a network and a storage device, in accordance with an embodiment of the present invention;

FIG. 12 is a flow chart of a method of directly transferring a file between a network and a storage device, in accordance with an embodiment of the present invention; and

FIG. 13 is a flow chart of a method of directly transferring a file between a network and a storage device, in accordance with an embodiment of the present invention.

### DESCRIPTION

In various embodiments, a host processor of a computing host receives a file request for transferring a file between a network and a storage device. The host processor generates a command based on the file request for directly transferring the file. A communication processor of the computing host transfers the file between the network and the storage device based on the command without passing the file through the host processor.

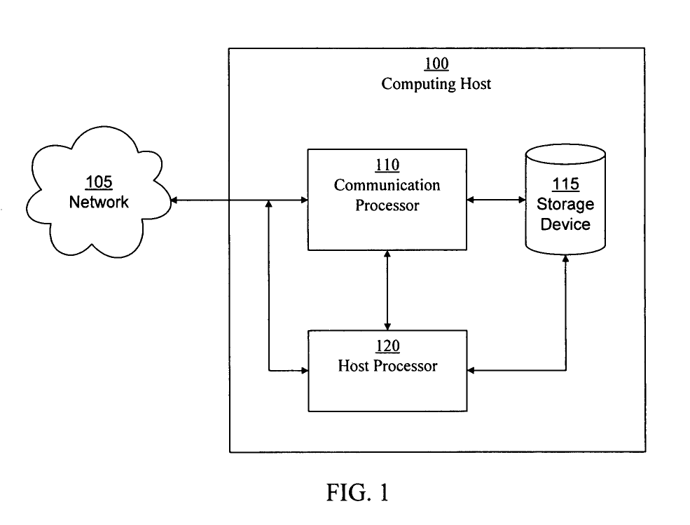

FIG. 1 illustrates a computing host 100, in accordance with an embodiment of the present invention. The computing host 100 includes a communication processor 110, a storage device 115, and a host processor 120. The communication processor 110 is coupled in communication with a network 105, the storage device 115, and the host processor 120. The host processor 120 is coupled in communication with the storage device 115 and may also be coupled in communication with the network 105.

The network 105 may include a local area network (LAN), a wide area network (WAN), a wireless network, the Internet, a cellular network, a wireless data transmission system, a two-way cable system, a customized computer network, an interactive kiosk network, a satellite network, a broadband network, a baseband network, a computer system or server, or the like, as well as any combination thereof. The communication processor 110 may include hardware or software, or both, for communicating with the network 105 or the storage device 115. Moreover, the communication processor 110 may communicate with any number of input/output (I/O) devices, systems, or networks. For example, the communication processor 110 may communicate with multiple storage devices 115 or multiple networks 105, or both. The storage device 115 may include any computing device, hardware, or software, for storing data. For example, the storage device 115 may include a redundant array of inexpensive disks (RAID), a storage area network (SAN), a small computer system interface (SCSI) disk, a disk drive, a solid-state drive, a flash memory, a flash storage array, a solid-state memory, a flash storage device, or the like. The storage device 115 may include several computer storage devices, which may be the same type of computer storage device or a combination of different types of computer storage devices.

The host processor 120 includes a computing device such as, for example, a network server, a server system, a mainframe computer, a personal computer, or the like. In one embodiment, the host processor 120 comprises a Web server including a computer program for serving Hypertext Markup Language (HTML) pages or files requested by client systems in the network 105. In another embodiment, the host processor 120 receives media requests from client systems in the network 105 and provides media content to the client systems in response to the media requests. The host processor 120 may include various types of program logic to control operation of the host processor 120. The program logic may include hardware or software components, such as object-oriented software components, class components, task components, processes, methods, functions, attributes, procedures, subroutines, program code segments, drivers, firmware, microcode, algorithms, techniques, programs, applications, data, databases, data structures, tables, arrays, variables, or the like.

The host processor 120 receives a file request from the network 105 for transferring a file between the network 105 and the storage device 115 and determines whether the file request is to be performed by using a direct file transfer, as is described more fully herein. For example, a file may be a data file, a program file, an executable file, an object file, a control file, a portion of a file, multiple files, a data structure, a data stream, data blocks, data bytes, data bits, or the like. If the file request is to be performed by using a direct file transfer, the host processor 120 generates a command based on the file request and provides the command to the communication processor 110. The communication processor 110 processes the command to transfer the file between the network 105 and the storage device 115 without passing the file through the host processor 120. In this way, the file is directly transferred between the network 105 and the storage device 115 (e.g., the file is accessed in the storage device 115 without passing the file through the host processor 120). The communication processor 110 transfers the file between the network 105 and the storage device 115 by reading the file in the storage device 115 and transmitting the file to the network 105. Alternatively, the communication processor 110 transfers the file between the network 105 and the storage device 115 by receiving the file from the network 105 and storing the file into the storage device 115.

If the host processor 120 determines that the file request is not to be performed by using a direct file transfer, the host processor 120 transfers the file between the network 105 and the storage device 115 based on the file request. The host processor 120 transfers the file between the network 105 and the storage device 115 by reading the file in the storage device 115 and transmitting the file to the network 105. Alternatively, the host processor 120 transfers the file between the network 105 and the storage device 115 by receiving the file from the network 105 and writing the file into the storage device 115. In one embodiment, the host processor 120 reads the file in the storage device 115 and provides the file to the communication processor 110. In turn, the communication processor 110 receives the file from the host processor 120 and transmits the file to the network 105. In another embodiment, the communication processor 110 receives the file of the file request from the network 105 and provides the file to the host processor 120. In turn, the host processor 120 receives the file from the communication processor 110 and writes the file into the storage device 115. In addition to transferring the file between the network 105 and the storage device 115 based on the file request, the host processor 120 also processes the file, for example by executing a computing application on the file.

In one embodiment, the host processor 120 determines whether the file request is to be performed by using a direct file transfer based on whether data in the file is to be processed by a computing application in the host processor 120 during the data transfer. The host processor 120 determines whether the file request is to be processed by a computing application in the host processor 120 based on the file request. Data in a file that need not be processed by a computing application in the host processor 120 during transfer of the file is generally referred to as static data. For example, static data may include streaming data that uses peer-to-peer transactions for transferring media files, such as audio files and video files. Data in a file that is to be processed by a computing application in the host processor 120 during transfer of the file is generally referred to as dynamic data. For example, dynamic data may include data to be encrypted or decrypted during the data transfer. Because static data need not be processed by a computing application in the host processor 120, the communication processor 110 transfers a file containing the static data between the network 105 and the storage device 115 without passing the file through the host processor 120. Stated differently, the communication processor 110 directly transfers the file between the network 105 and the storage device 115.

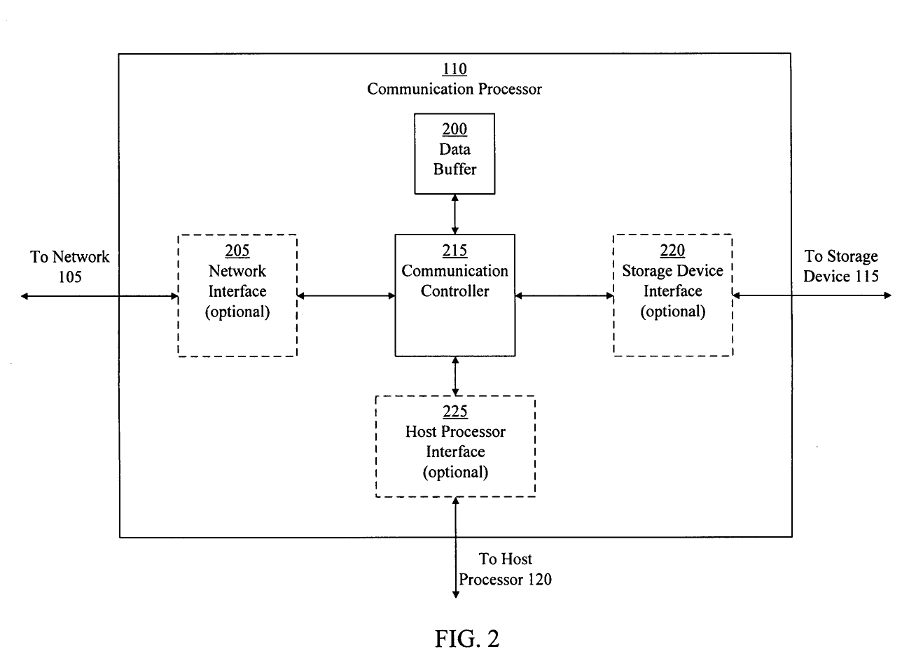

FIG. 2 illustrates the communication processor 110, in accordance with an embodiment of the present invention. The communication processor 110 includes a data buffer 200 and a communication controller 215. The communication controller 215 is coupled in communication with the data buffer 200, the network 105, the storage device 115, and the host processor 120. The communication controller 215 includes any device, component, or software that facilitates and manages the transfer of data between the network 105 and the storage device 115. For example, the communication controller 215 may include a microprocessor, a microcontroller, an embedded processor, a logic circuit, or the like. The data buffer 200 may be any memory, computing device, or system capable of storing data. For example, the data buffer 200 may be a random access memory (RAM), a read-only-memory (ROM), a programmable ROM (PROM), an erasable programmable ROM (EPROM), a flash memory, or the like.

The communication controller 215 receives a command from the host processor 120 for transferring a file in the storage device 115 and transfers the file in the storage device 115 based on the command. In one embodiment, the communication controller 215 receives a file request from the network 105 and provides the file request to the host processor 120. In response to receiving the file request, the host processor 120 generates the command based on the file request and provides the command to the communication controller 215. In an alternative embodiment, the host processor 120 receives the file request from the network 105, generates the command based on the file request in response to receiving the file request, and provides the command to the communication controller 215.

In one embodiment, the communication controller 215 transfers the file in the storage device 115 by receiving data packets for the file request from the network 105, identifying data payloads in the data packets based on a command received from the host processor 120, and storing the data payloads into the data buffer 200 to construct the file. In this embodiment, each of the data payloads includes a portion of the file. The communication controller 215 then reads the file, or a portion of the file, in the data buffer 200 and writes the file, or a portion of the file, into the storage device 115. In other embodiments, the communication controller 215 identifies the data payloads in the data packets based on the command and writes the data payloads into the storage device 115 without writing the data packets into the data buffer 200. In this way, the communication controller 215 writes the file into the storage device 115 without writing overhead in the data packets into the storage device 115.

In one embodiment, the communication controller 215 transfers the file in the storage device 115 by reading the file in the storage device 115 and writing the file into the data buffer 200. The communication controller 215 then generates one or more data packets based on a command received from the host processor 120 and the file, and transmits the data packets to the network 105. Each of the data packets includes a data payload and a header. The data payload includes a portion of the file. The header may include control or routing information for the data packet, such as a destination address in the network 105 for the data packet. For example, the data packet may be an Internet Protocol (IP) packet.

In one embodiment, the host processor 120 generates the headers of the data packets based on the file request and provides the headers to the communication controller 215. For example, the host processor 120 may include the headers in a command generated by the host processor 120. In this embodiment, the communication controller 215 identifies the data payloads from the file and combines the data payloads with the headers received from the host processor 120 to generate the data packets. In another embodiment, the host processor 120 generates the headers of the data packets based on the file request and stores the headers. Additionally, the host processor 120 provides addresses of the headers to the communication controller 215. In this embodiment, the communication controller 215 retrieves the headers from the host processor 120 based on the addresses and combines the data payloads with the headers to generate the data packets. In still another embodiment, the communication controller 215 generates the headers for the data packets based on a command received from the host processor 120.

The communication processor 110 may include an optional network interface 205 coupled in communication with the network 105 and the communication controller 215. In embodiments with the network interface 205, the communication controller 215 receives the file request from the network 105 via the network interface 205. In this process, the network interface 205 receives the file request from the network 105 and passes the file request to the communication controller 215. In turn, the communication controller 215 passes the file request to the host processor 120. In an alternative embodiment, the network interface 205 receives the file request from the network 105 and passes the file request to the host processor 120.

The communication processor 110 may include an optional storage device interface 220. The storage device interface 220 facilitates communications between the communication controller 215 and the storage device 115. The storage device interface 220 may include any device capable of connecting the communication processor 110 to one or more storage devices 115. For example, the storage device interface 220 may include a small computer systems interface (SCSI), an integrated drive electronics (IDE) interface, an advanced technology attachment (ATA) interface, a flash storage interface, a Universal Serial Bus (USB) interface, or the like.

In embodiments with the storage device interface 220, the communication controller 215 transfers a file to or from the storage device 115 via the storage device interface 220. In this process, the communication controller 215 reads the file from the storage device 115, or writes the file into the storage device 115, via the storage device interface 220.

The communication processor 110 may include a host processor interface 225 coupled in communication with the communication controller 215 and the host processor 120. The host processor interface 225 may include any device, system, software, interconnect technology protocol, or device interface that enables the communication processor 110 to communicate with the host processor 120. In one embodiment, the host processor interface 225 includes a system bus, such as a peripheral component interconnect (PCI) bus, an industry standard architecture (ISA) bus, a micro channel architecture (MCA) bus, an extended industry standard architecture (EISA) bus, a Fibre Channel connection, or the like. For example, the system bus may be a PCI 2.0× bus or a PCI-X bus.

In embodiments with the host processor interface 225, the communication controller 215 provides a file request received from the network 105 to the host processor 120 via the host processor interface 225. In this process, the communication controller 215 passes the file request received from the network 105 to the host processor interface 225, and the host processor interface 225 passes the file request to the host processor 120.

In one embodiment, the host processor 120 includes application programs that enable the host processor 120 to communicate with the communication processor 110 via the host processor interface 225. For example, the application programs may include plug-and-play technology which establishes a communication channel between the communication processor 110 and the host processor 120 upon connection of the communication processor 110 to the host processor 120 via the host processor interface 225.

In one embodiment, the host processor 120 does not initially include the appropriate applications or programs for enabling communication between the host processor 120 and the communication processor 110 via the host processor interface 225. In this embodiment, program logic may be added to the host processor 120 for enabling the host processor 120 to communicate with the communication processor 110 via the host processor interface 225. Such program logic may be transparent, or introduce minimal changes, to the host processor 120 or applications in the host processor 120. In one embodiment, the program logic is a computer program installed on the host processor 120 before the host processor 120 is connected to the host processor interface 225. Moreover, the program logic may be tailored for a given computing platform of the host processor 120. For example, the computing platform may be based on Microsoft Windows, UNIX, Linux, or the like.

In one embodiment, the host processor interface 225 facilitates different types of communications between the communication processor 110 and the host processor 120. Examples of communications between the communication processor 110 and the host processor 120 include protocol for encoding data; authorization, authentication, and accounting (AAA) information; commands; requests; request-fulfilled commands; and file information, such as the names or locations of files. The communications between the communication processor 110 and the host processor 120 may be based on a communication protocol or may be independent of a communication protocol. In one embodiment, the host processor interface 225 remains active or open throughout the operation of the communication processor 110 and the host processor 120. In other embodiments, the host processor interface 225 may be deactivated or disabled, for example when communication is not needed or not desired between the communication processor 110 and the host processor 120.

In various embodiments, each of the network interface 205, the storage device interface 220, and the host processor interface 225 may be internal, external, partially internal, or partially external of the communication processor 110. Moreover, in some embodiments, the communication processor 110 may operate without one or more of the network interface 205, the storage device interface 220, or the host processor interface 225. In other embodiments, the communication processor 110 may operate with one or more of the network interface 205, the storage device interface 220, or the host processor interface 225.

In some embodiments, the network interface 205, the storage device interface 220, or the host processor interface 225, or any combination thereof, includes one or more data buffers to synchronize or facilitate effective transmission of communications with the communication processor 110. For example, the communication processor 110 may communicate with the network 105 via the network interface 205 using an Ethernet protocol, an asynchronous transfer mode (ATM) protocol, a synchronous optical network (SONET) protocol, or the like. As another example, the communication processor 110 may communicate with the storage device 115 via the storage device interface 220 or with the host processor 120 via the host processor interface 225 by using a small computer systems interconnect (SCSI) protocol, an Internet SCSI (iSCSI), a Fibre Channel protocol, a peripheral component interconnect (PCI) protocol, an InfiniBand protocol, a flash storage protocol, a Universal Serial Bus (USB) protocol, or the like.

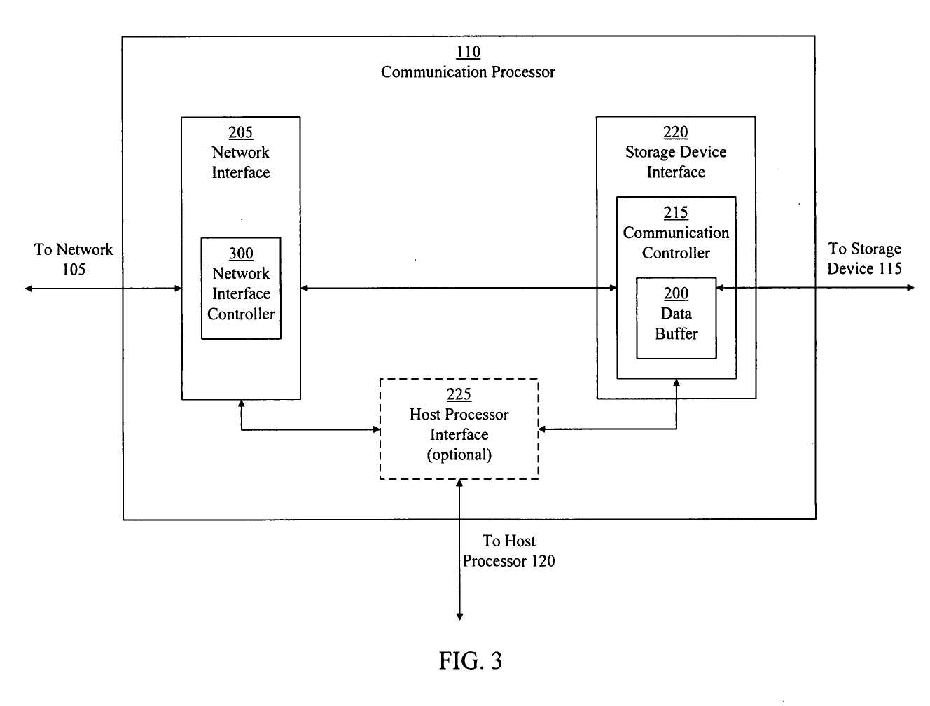

FIG. 3 illustrates the communication processor 110, in accordance with another embodiment of the present invention. In this embodiment, the storage device interface 220 includes the communication controller 215 and the data buffer 200. Further; the communication controller 215 may include the data buffer 200. In other embodiments, the data buffer 200 may be external of the communication controller 215 or external of the communication processor 110. Also in this embodiment, the network interface 205 includes a network interface controller 300. The network interface controller 300 facilitates communication between the network 105 and the communication controller 215, and between the network 105 and the host processor 120.

In one embodiment, the communication controller 215 includes a host bus adapter (HBA), which performs low-level interface functions with the storage device 115 automatically or with minimal interaction with the host processor 120. For example, the communication controller 215 may include a HBA that performs low-level functions in a communication protocol, such as a peripheral component interconnect (PCI) protocol, a SCSI protocol, an Internet SCSI (iSCSI) protocol, a Fibre Channel protocol, an integrated device electronics (IDE) protocol, or the like.

In one embodiment, the network interface controller 300 includes a network interface card, such as a Gigabit Ethernet Network Interface Card (GbE NIC). In another embodiment, the network interface controller 300 includes a Network Interface Module (NIM). In still another embodiment, the network interface controller 300 includes software for facilitating communication between the network 105 and the communication processor 110. For example, the network interface controller 300 may include a Network Interface Device Driver (NIDD) for retrieving data packets from a receiving buffer in the NIM and distributing the data packets to the communication controller 215.

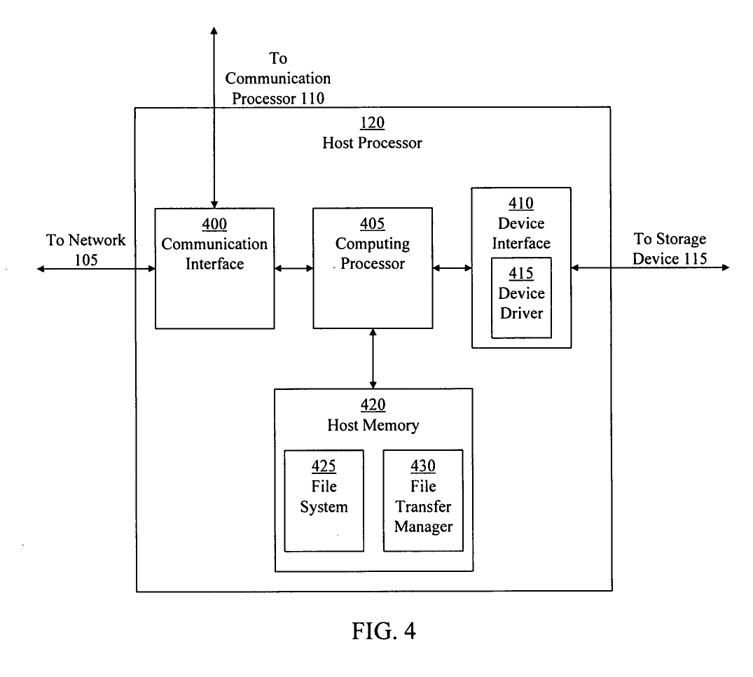

FIG. 4 illustrates the host processor 120, in accordance with an embodiment of the present invention. The host processor 120 includes a communication interface 400, a computing processor 405, a device interface 410, and a host memory 420. The communication interface 400 is coupled in communication with the communication processor 110 and the computing processor 405, and facilitates communication between the communication processor 110 and the computing processor 405. Additionally, the communication interface 400 may be coupled in communication with the network 105 for facilitating communication between the network 105 and the computing processor 405. The computing processor 405 may be a microprocessor, a microcontroller, an embedded controller, a logic circuit, or the like.

The device interface 410 is coupled in communication with the computing processor 405 and the storage device 115, and facilitates communication between the computing processor 405 and the storage device 115. In one embodiment, the device interface 410 includes a device driver 415 for facilitating communication between the computing processor 405 and the storage device 115. For example, the device driver 415 may be software or firmware in the device interface 410. In one embodiment, the device driver 415 includes a dynamic link library (DLL) file.

The host memory 420 is coupled in communication with the computing processor 405 and stores data, such as computing instructions, for the computing processor 405. The host memory 420 may be any device or system capable of storing data. For example, the host memory 420 may be a dynamic random access memory (DRAM), a synchronous dynamic random access memory (SDRAM), a read-only memory (ROM), a programmable ROM (PROM), an erasable programmable ROM (EPROM), or the like. In some embodiments, the computing processor 405 includes the host memory 420.

The host processor 120 further includes a file system 425 and a file transfer manager 430. The file system 425 organizes files for storage in, and retrieval from, the storage device 115. In one embodiment, the file system 425 includes a computer file system for managing files. The computer file system may include any device, system, software, data structures, or algorithms by which files are named, identified, and organized for storage and retrieval. For example, the file system 425 may organize files in directories having a hierarchical or tree structure and may include a convention for naming or identifying the files. The file system 425 may also include a format for specifying the path to a file through directory structure. In one embodiment, the file system 425 is a Linux-based file system, and in another embodiment, the file system 425 is a Windows-based file system. In one embodiment, the file system 425 is a software program stored in the host memory 420 as illustrated in FIG. 4. In this embodiment, the computing processor 405 executes the file system 425 to manage the files in the storage device 115.

The file transfer manager 430 identifies a file in the storage device 115 based on a file request received by the host processor 120 and the file system 425. The file transfer manager 430 may be any device, system, software, data structures, or algorithms for identifying a file. In one embodiment, the file transfer manager 430 identifies an address of the file in the storage device 115 based on the file request and the file system 425. The computing processor 405 then transfers the file in the storage device 115 based on the address of the file. Additionally, the file transfer manager 430 provides the address of the file to the communication processor 110, and the communication processor 110 transfers the file in the storage device 115 based on the address.

In one embodiment, the file transfer manager 430 is a software program stored in the host memory 420 as illustrated in FIG. 4. In this embodiment, the computing processor 405 executes or uses the file transfer manager 430 to identify an address of a file based on a file request and the file system 425. In a further embodiment, the computing processor 405 generates a command including the data address for transferring the file in the storage device 115. The communication processor 110 identifies the file in the storage device 115 based on the address in the command and transfers the file at the address in the storage device 115.

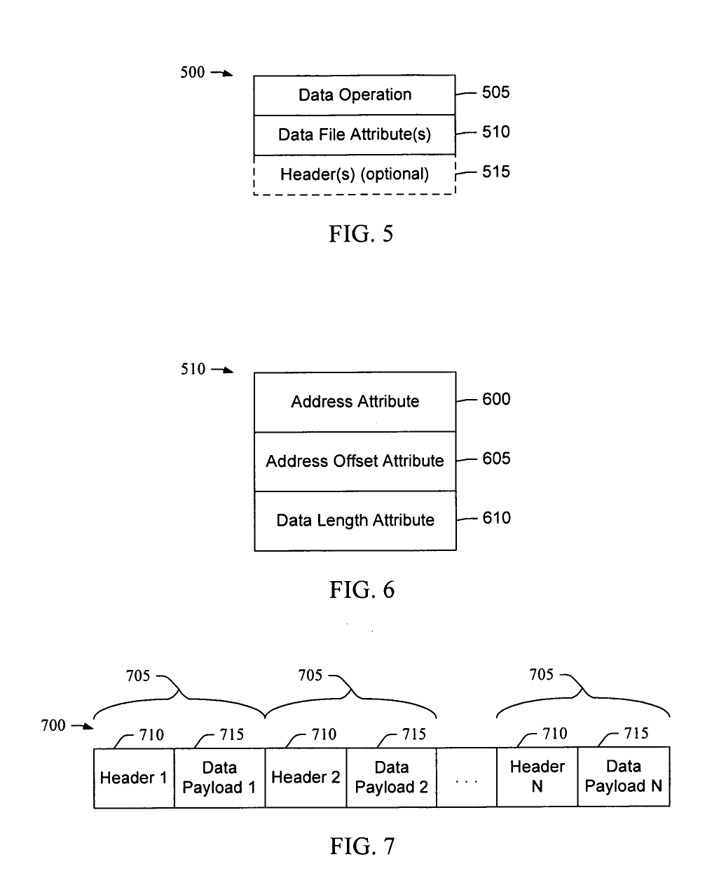

FIG. 5 illustrates a command 500, in accordance with an embodiment of the present invention. The command 500 includes a data operation 505, a file attribute portion 510, and an optional header portion 515. The data operation 505 specifies an operation to be performed on a file. For example, the data operation 505 may be a read data operation for reading a file in the storage device 115 or a write operation for writing a file into the storage device 115. The file attribute portion 510 includes one or more attributes for identifying the file. For example, the file attribute portion 510 may include an attribute, such as an address, for identifying the location of the file in the storage device 115. Additionally, the file attribute portion 510 may include attributes for identifying data payloads from the file for generating data packets. The header portion 515 includes one or more headers for the data packets. Alternatively, the header portion 515 includes one or more identifiers for identifying the headers, such as pointers, addresses, or flags.

FIG. 6 illustrates the file attribute portion 510 of the command 500, in accordance with an embodiment of the present invention. The file attribute portion 510 includes an address attribute 600 identifying an address of a file in the storage device 115. Additionally, the file attribute portion 510 includes an address offset attribute 605 identifying an address offset for a data payload in the file and a data length attribute 610 specifying a data length for the data payload. In other embodiments, the file attribute portion 510 may have more than one address offset attribute 605 and more than one data length attribute 610.

FIG. 7 illustrates a data message 700, in accordance with an embodiment of the present invention. The data message 700 includes data packets 705 generated for a file, as is described more fully herein. As shown in FIG. 7, each data packet 705 includes a header 710 and a data payload 715. In one embodiment, the communication controller 215 combines the data packets 705 to generate the data message 700 based on a command received from the host processor 120 and transmits the data message 700 to the network 105. Moreover, the command may specify the data size of the data packet 705. For example, a message packet to be sent over an Ethernet network may be 1.5 kilobytes in size. In other embodiment, the network interface controller 300 segments the data message 700 into appropriate sized data portions and transmits the data portions to the network 105.

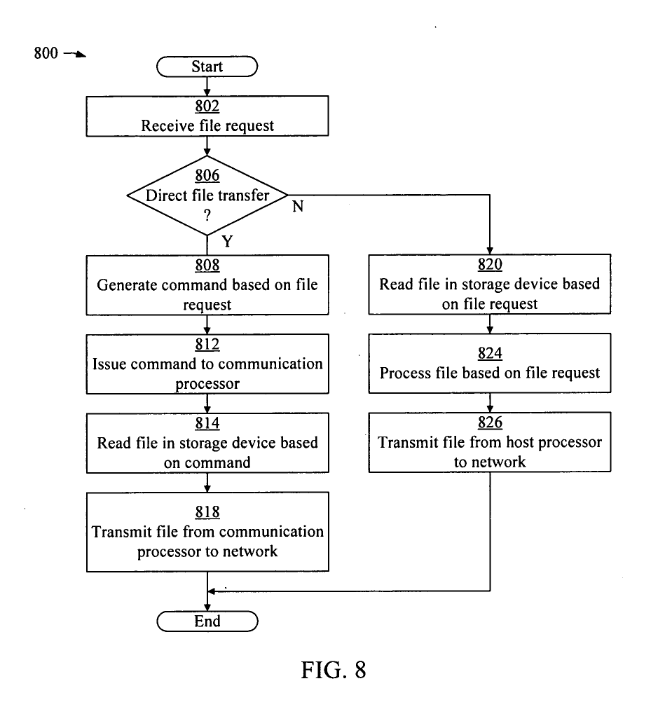

FIG. 8 illustrates a method 800 of directly transferring a file between a network and a storage device, in accordance with an embodiment of the present invention. In this method, a file is read from the host processor 120. In step 802, the host processor 120 receives a file request for reading a file in the storage device 115. In one embodiment, the communication processor 110 receives the file request from the network 105 and provides the file request to the host processor 120. In turn, the host processor 120 receives the file request from the communication processor 110. In another embodiment, the host processor 120 receives the file request from the network 105. The method 800 then proceeds to step 806.

In step 806, the host processor 120 determines whether the file request is to be performed by using a direct file transfer. In one embodiment, the host processor 120 determines whether the file request is to be performed by using a direct file transfer by determining based on the file request whether the host processor 120 is to execute a computing application on the file. If the host processor 120 is to execute a computing application on the file, the host processor 120 determines that the file request is not to be performed by using a direct file transfer and the method 800 proceeds to step 820. Otherwise, the host processor 120 determines that the file request is to be performed by using a direct file transfer and the method 800 proceeds to step 808.

In step 808, arrived at from the determination in step 806 that the file request is to be performed by using a direct file transfer, the host processor 120 generates a command based on the file request for reading the file in the storage device 115. The method 800 then proceeds to step 812.

In step 812, the host processor 120 issues the command to the communication processor 110. The method 800 then proceeds to step 814.

In step 814, the communication processor 110 reads the file in the storage device 115 based on the command. In one embodiment, the communication controller 215 of the communication processor 110 reads the file in the storage device 115 based on the command and writes the file into the data buffer 200. In another embodiment, the communication controller 215 also generates data packets based on the file and the command, as is described more fully herein. Additionally, the communication controller 215 writes the data packets into the data buffer 200. The method 800 then proceeds to step 818.

In step 818, the communication processor 110 transmits the file to the network 105. In one embodiment, the communication controller 215 of the communication processor 110 transmits the file to the network 105 by transmitting the data packets generated for the file to the network 105. The method 800 then ends.

In step 820, arrived at from the determination in step 806 that the file request is not to be performed by using a direct file transfer, the host processor 120 reads the file in the storage device 115 based on the file request and stores the file. In one embodiment, the computing processor 405 of the host processor 120 reads the file in the storage device 115 and writes the file into the host memory 420. The method 800 then proceeds to step 824.

In step 824, the host processor 120 processes the file based on the file request. The host processor 120 may process the file by executing a computing application on the file. In one embodiment, the computing processor 405 of the host processor 120 executes a computing application on the file to process the file. The method 800 then proceeds to step 826.

In step 826, the host processor 120 transmits the file to the network 105. In one embodiment, the host processor 120 transmits the file to the network 105 via the communication processor 110. In this embodiment, the host processor 120 provides the file to the communication processor 110, and the communication processor 110 transmits the file to the network 105. The method 800 then ends.

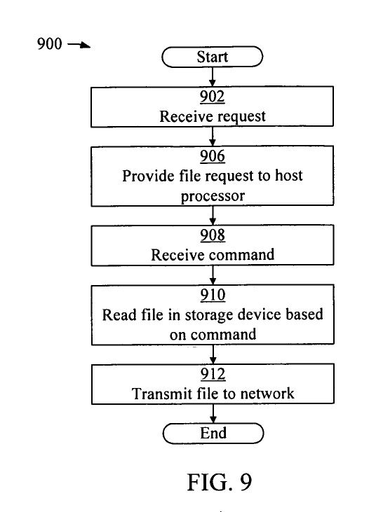

FIG. 9 illustrates a method 900 of directly transferring a file between a network and a storage device, in accordance with an embodiment of the present invention. In this method, a file is read from the host processor 120. In step 902, the communication processor 110 receives a file request from the network 105 for reading a file in the storage device 115. The method 900 then proceeds to step 906.

In step 906, the communication processor 110 provides the file request to the host processor 120. The method 900 then proceeds to step 908.

In step 908, the communication processor 110 receives a command from the host processor 120 for reading a file in the storage device 115. In one embodiment, the communication processor 110 receives the command from the host processor 120 in response to the file request. The method 900 then proceeds to step 910.

In step 910, the communication processor 110 reads the file in storage device 115 based on the command. In one embodiment, the communication controller 215 of the communication processor 110 reads the file in the storage device 115 based on the command and writes the file into the data buffer 200. In another embodiment, the communication controller 215 also generates data packets based on the file and the command, as is described more fully herein. Additionally, the communication controller 215 may write the data packets into the data buffer 200. The method 900 then proceeds to step 912.

In step 912, the communication processor 110 transmits the file to the network 105. In one embodiment, the communication controller 215 of the communication processor 110 transmits the file to the network 105 by transmitting the data packets generated for the file to the network 105. The method 900 then ends.

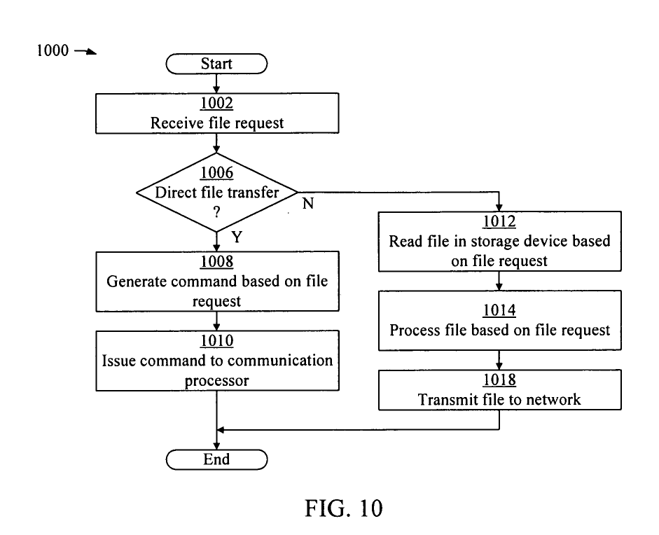

FIG. 10 illustrates a method 1000 of directly transferring a file between a network and a storage device, in accordance with an embodiment of the present invention. In step 1002, the host processor 120 receives a file request for reading a file in the storage device 115. In one embodiment, the host processor 120 receives the file request from the communication processor 110. In another embodiment, the host processor 120 receives the file request from the network 105. The method 1000 then proceeds to step 1006.

In step 1006, the host processor 120 determines whether the file request is to be performed by using a direct file transfer. In one embodiment, the host processor 120 determines whether the file request is to be performed by using a direct file transfer by determining based on the file request whether the host processor 120 is to execute a computing application on the file. If the host processor 120 is to execute a computing application on the file, the host processor 120 determines that the file request is not to be performed by using a direct file transfer and the method 1000 proceeds to step 1012. Otherwise, the host processor 120 determines that the file request is to be performed by using a direct file transfer and the method 1000 proceeds to step 1008.

In step 1008, arrived at from the determination in step 1006 that the file request is to be performed by using a direct file transfer, the host processor 120 generates a command based on the file request for reading the file in the storage device 115. The method 1000 then proceeds to step 1010.

In step 1010, the host processor 120 issues the command to the communication processor 110. The method 1000 then ends.

In step 1012, arrived at from the determination in step 1006 that the file request is not to be performed by using a direct file transfer, the host processor 120 reads the file in the storage device 115 based on the file request and stores the file. In one embodiment, the computing processor 405 of the host processor 120 reads the file in the storage device 115 and writes the file into the host memory 420. The method 1000 then proceeds to step 1014.

In step 1014, the host processor 120 processes the file based on the file request. The host processor 120 may process the file by executing a computing application on the file. In one embodiment, the computing processor 405 of the host processor 120 executes the computing application on the file to process the file. The method 1000 then proceeds to step 1018.

In step 1018, the host processor 120 transmits the file to the network 105. In one embodiment, the host processor 120 transmits the file to the network 105 via the communication processor 110. In this process, the host processor 120 provides the file to the communication processor 110, and the communication processor 110 transmits the file to the network 105. The method 1000 then ends.

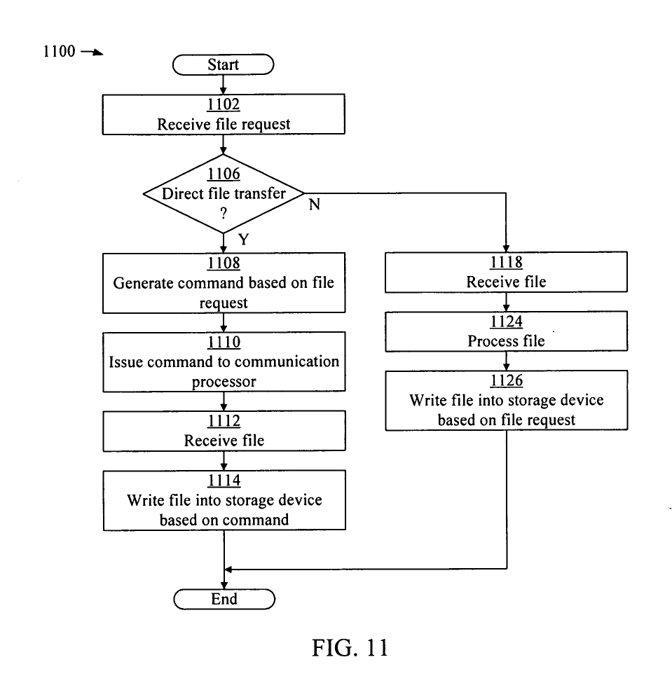

FIG. 11 illustrates a method 1100 of directly transferring a file between a network and a storage device, in accordance with an embodiment of the present invention. In this method, a file is written into the host processor 120. In step 1102, the host processor 120 receives a file request for writing a file into the storage device 115. In one embodiment, the communication processor 110 receives the file request from the network 105 and provides the file request to the host processor 120. In turn, the host processor 120 receives the file request from the communication processor 110. In another embodiment, the host processor 120 receives the file request from the network 105. The method 1100 then proceeds to step 1106.

In step 1106, the host processor 120 determines whether the file request is to be performed by using a direct file transfer. In one embodiment, the host processor 120 determines whether the file request is to be performed by using a direct file transfer by determining based on the file request whether the host processor 120 is to execute a computing application on the file. If the host processor 120 is to execute a computing application on the file, the host processor 120 determines that the file request is not to be performed by using a direct file transfer and the method 1100 proceeds to step 1118. Otherwise, the host processor 120 determines that the file request is to be performed by using a direct file transfer and the method 1100 proceeds to step 1108.

In step 1108, arrived at from the determination in step 1106 that the file request is to be performed by using a direct file transfer, the host processor 120 generates a command based on the file request for writing the file into the storage device 115. The method 1100 then proceeds to step 1110.

In step 1110, the host processor 120 issues the command to the communication processor 110. The method 1100 then proceeds to step 1112.

In step 1112, the communication processor 110 receives the file from the network 105. In one embodiment, the communication controller 215 of the communication processor 110 receives the file from the network 105 and stores the file into the data buffer 200. In another embodiment, the communication controller 215 receives the file by receiving data packets from the network 105 and identifying data payloads in the data packets. The communication controller 215 may also store the data payloads into the data buffer 200 to construct the file. The method 1100 then proceeds to step 1114.

In step 1114, the communication processor 110 writes the file into the storage device 115 based on the command. In one embodiment, the communication controller 215 of the communication processor 110 reads the file in the data buffer 200 and writes the file into the storage device 115 based on the command. In another embodiment, the communication controller 215 writes data payloads of data packets for the file into the storage device 115 to construct the file in the storage device 115. The method 1100 then ends.

In step 1118, arrived at from the determination in step 1106 that the file request is not to be performed by using a direct file transfer, the host processor 120 receives the file of the file request and stores the file. In one embodiment, the host processor 120 receives the file from the network 105. In another embodiment, the communication processor 110 receives the file from the network 105 and provides the file to the host processor 120. In turn, the host processor 120 receives the file from the communication processor 110. In still another embodiment, the computing processor 405 of the host processor 120 writes the file into the host memory 420.

In another embodiment, the host processor 120 receives the file by receiving data packets for the file from the network 105 or the communication processor 110. In this embodiment, the computing processor 405 of the host processor 120 identifies data payloads in the data packets and writes the data payloads into the host memory 420 to construct the file. The method 1100 then proceeds to step 1124.

In step 1124, the host processor 120 processes the file based on the file request. The host processor 120 may process the file by executing a computing application on the file. In one embodiment, the computing processor 405 of the host processor 120 executes the computing application on the file to process the file. The method 1100 then proceeds to step 1126.

In step 1126, the host processor 120 writes the file into the storage device 115 based on the file request. The method 1100 then ends.

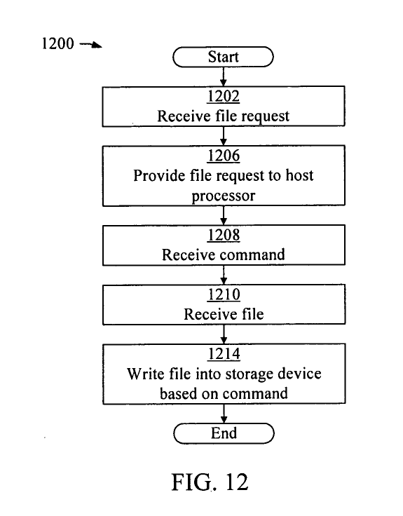

FIG. 12 illustrates a method 1200 of directly transferring a file between a network and a storage device, in accordance with an embodiment of the present invention. In this method, a file is written into the host processor 120. In step 1202, the communication processor 110 receives a file request from the network 105. The method 1200 then proceeds to step 1206.

In step 1206, the communication processor 110 provides the file request to the host processor 120. The method 1200 then proceeds to step 1208.

In step 1208, the communication processor 110 receives a command for writing a file into the storage device 115. In one embodiment, the communication processor 110 receives the command from the host processor 120 in response to sending the file request to the host processor 120. The method 1200 then proceeds to step 1210.

In step 1210, the communication processor 110 receives the file from the network 105. In one embodiment, the communication controller 215 of the communication processor 110 receives the file from the network 105 and stores the file into the data buffer 200. In another embodiment, the communication controller 215 receives the file by receiving data packets from the network 105 and identifying data payloads in the data packets. The communication controller 215 may also store the data payloads into the data buffer 200 to construct the file. The method 1200 then proceeds to step 1214.

In step 1214, the communication processor 110 writes the file into the storage device 115 based on the command. In one embodiment, the communication controller 215 of the communication processor 110 reads the file in the data buffer 200 and writes the file into the storage device 115 based on the command. In another embodiment, the communication controller 215 writes data payloads of data packets for the file into the storage device 115 to construct the file in the storage device 115. The method 1200 then ends.

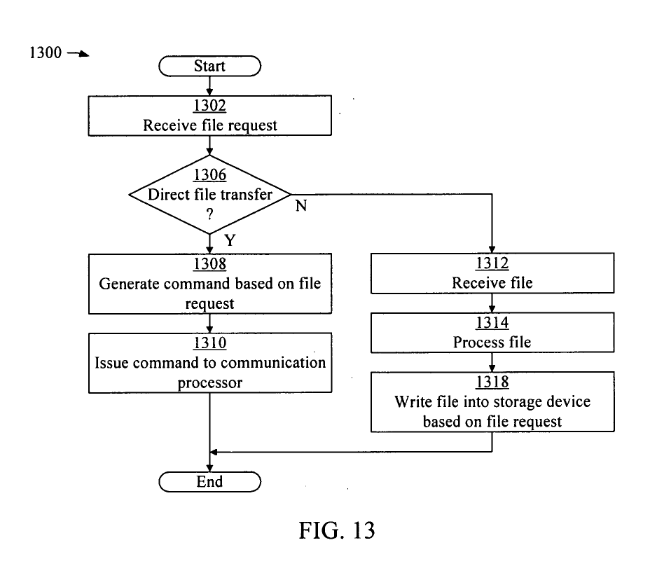

FIG. 13 illustrates a method 1300 of directly transferring a file between a network and a storage device, in accordance with an embodiment of the present invention. In this method, a file is written into the host processor 120. In step 1302, the host processor 120 receives a file request for writing a file into the storage device 115. In one embodiment, the host processor 120 receives the file request from the communication processor 110. In another embodiment, the host processor 120 receives the file request from the network 105. The method 1300 then proceeds to step 1306.

In step 1306, the host processor 120 determines whether the file request is to be performed by using a direct file transfer. In one embodiment, the host processor 120 determines whether the file request is to be performed by using a direct file transfer by determining based on the file request whether the host processor 120 is to execute a computing application on the file. If the host processor 120 is to execute a computing application on the file, the host processor 120 determines that the file request is not to be performed by using a direct file transfer and the method 1300 proceeds to step 1312. Otherwise, the host processor 120 determines that the file request is to be performed by using a direct file transfer and the method 1300 proceeds to step 1308.

In step 1308, arrived at from the determination in step 1306 that the file request is to be performed by using a direct file transfer, the host processor 120 generates a command based on the file request for writing the file into the storage device 115. The method 1300 then proceeds to step 1310.

In step 1310, the host processor 120 issues the command to the communication processor 110. The method 1300 then ends.

In step 1312, arrived at from the determination in step 1306 that the file request is not to be performed by using a direct file transfer, the host processor 120 receives the file of the file request and stores the file. In one embodiment, the computing processor 405 of the host processor 120 writes the file into the host memory 420. In one embodiment, the host processor 120 receives the file from the network 105. In another embodiment, the communication processor 110 receives the file from the network 105 and provides the file to the host processor 120. In turn, the host processor 120 receives the file from the communication processor 110.

In another embodiment, the host processor 120 receives the file by receiving data packets for the file from the network 105 or the communication processor 110. In this embodiment, the computing processor 405 of the host processor 120 identifies data payloads in the data packets and writes the data payloads into the host memory 420 to construct the file. The method 1300 then proceeds to step 1314.

In step 1314, the host processor 120 processes the file based on the file request. The host processor 120 may process the file by executing a computing application on the file. In one embodiment, the computing processor 405 of the host processor 120 executes the computing application on the file to process the file. The method 1300 then proceeds to step 1318.

In step 1318, the host processor 120 writes the file into the storage device 115 based on the file request. The method 1300 then ends.

Although the invention has been described with reference to particular embodiments thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A method for directly transferring a file between a network and a storage device, the method comprising:
receiving a file request by a host processor coupled in communication with the storage device;
generating a command by the host processor based on the file request in response to receiving the file request;
issuing the command from the host processor to a communication processor coupled in communication with the network and the storage device; and
transferring the file between the network and the storage device based on the command without passing the file through the host processor.

2. The method of claim 1, wherein transferring the file between the network and the storage device based on the command without passing the file through the host processor comprises:
reading the file in the storage device by the communication processor; and
transmitting the file from the communication processor to the network.

3. The method of claim 2, wherein reading the file in the storage device by the communication processor based on the command without passing the file through the host processor comprises generating a plurality of data packets by the communication processor based on the command and the file, and wherein transmitting the file from the communication processor to the network comprises transmitting the plurality of data packets from the communication processor to the network.

4. The method of claim 3, wherein each data packet of the plurality of data packets comprises a header and a data payload, the command comprises the header of each data packet, generating the plurality of data packets by the communication processor based on the command and the file comprises identifying in the file the data payload of each data packet of the plurality of data packets, and wherein generating the command by the host processor based on the file request in response to receiving the file request comprises generating the header of each data packet of the plurality of data packets.

5. The method of claim 1, wherein transferring the file between the network and the storage device based on the command without passing the file through the host processor comprises:
receiving the file by the communication processor; and
writing the file into the storage device by the communication processor without passing the file through the host processor.

6. The method of claim 5, wherein receiving the file by the communication processor comprises receiving a plurality of data packets, each data packet of the plurality of data packets comprising a header and a data payload, and wherein writing the file into the storage device by the communication processor without passing the file through the host processor comprises writing the data payload of each data packet into the storage device.

7. The method of claim 1, wherein the host processor is a network server.

8. A system for transferring a file between a network and a storage device, the system comprising:
a host processor coupled in communication with the storage device, the host processor configured to receive a file request from the network and to generate a command based on the file request; and
a communication processor coupled in communication with the storage device and the host processor, the communication processor configured to transfer the file between the network and the storage device based on the command without passing the file through the host processor.

9. The system of claim 8, wherein the communication processor is further configured to transmit the file to the network.

10. The system of claim 8, wherein the communication processor is further configured to receive the file from the network.

11. The system of claim 8, wherein the communication processor comprises a controller configured to receive the file request and to send the file request to the host processor.

12. The system of claim 8, wherein the communication processor comprises a controller configured to receive the command from the host processor and to transfer the file between the network and the storage device based on the command.

13. The system of claim 12, wherein the host processor comprises:
a network interface coupled in communication with the communication processor, the network interface configured to receive the file request from the network, the network interface further configured to send the command to the communication processor; and
a computing processor coupled in communication with the network interface, the computing processor configured to generate the command based on the file request.

14. The system of claim 12, wherein the network interface is configured to receive the command from the communication processor.

15. The system of claim 12, wherein the host processor is further comprises:
a memory coupled in communication with the computing processor;
a file system in the memory configured to manage the file; and
a file transfer manager in the memory configured to identify the file in the storage device based on the file system.

16. The system of claim 12, wherein the host processor is a network server.

17. A system for directly transferring a file between a network and a storage device, the system comprising:
means for receiving a file request by a host processor coupled in communication with the storage device;
means for generating a command by the host processor based on the file request in response to receiving the file request;
means for issuing the command from the host processor to a communication processor coupled in communication with the network and the storage device; and
means for transferring the file between the network and the storage device based on the command without passing the file through the host processor.

18. The system of claim 17, wherein the means for transferring the file between the network and the storage device comprises:
means for reading the file in the storage device by the communication processor; and
means for transmitting the file from the communication processor to the network.

19. The system of claim 17, wherein the means for transferring the file between the network and the storage device comprises:
means for receiving the file from the network by the communication processor; and
means for writing the file into the storage device by the communication processor without passing the file through the host processor.

20. The system of claim 17, wherein the host processor is a network server.
